(19) United States
(12) Patent Application Publication
(10) Pub. No.: US 2022/0033985 A1
(43) Pub. Date: Feb. 3, 2022

(54) SYSTEMS AND METHODS FOR THE ELECTROCHEMICAL CONVERSION OF CHALCOPYRITE TO ENABLE HYDROMETALLURGICAL EXTRACTION OF COPPER

(71) Applicant: THE TRUSTEES OF COLUMBIA UNIVERSITY IN THE CITY OF NEW YORK, New York, NY (US)

(72) Inventors: Alan WEST, Tenafly, NJ (US); Scott BANTA, Fairfield, CT (US); Jon VARDNER, New York, NY (US); Campbell DONNELLY, New York, NY (US); Zhengyan ZHANG, Changshu (CN)

(73) Assignee: THE TRUSTEES OF COLUMBIA UNIVERSITY IN THE CITY OF NEW YORK, New York, NY (US)

(21) Appl. No.: 17/390,087

(22) Filed: Jul. 30, 2021

Related U.S. Application Data
(60) Provisional application No. 63/058,544, filed on Jul. 30, 2020.

(51) Int. Cl. C25B 15/08; C25B 1/01; C25B 9/40; C25B 11/037; C25B 11/042; C25B 13/02; C22B 15/00

(52) U.S. Cl. CPC C25B 15/081; C25B 1/01; C25B 9/47; C22B 15/0004; C25B 11/042; C25B 13/02; C25B 11/037

(57) ABSTRACT

An electrochemical system and process are provided to convert an amount of chalcopyrite (CuFeS₂) to a product including copper ions. In an electrochemical reactor, a potential is applied across an anode and a cathode to convert the chalcopyrite to an intermediate, chalcocite (Cu₂S). The anode is covered to prevent contact with the intermediate, thus limiting subsequent conversion of the intermediate to covellite (CuS) in favor of conversion to a material more suited to chemical oxidation, cuprite (Cu₂O). For example, the anode can be covered with one or more layers of filter paper. Upon application of an oxidizing agent, the cuprite is oxidized to produce a product including copper ions. The cathode and covered anode allow for efficient and inexpensive processing. The cost of this technique is comparable to industry standards, and moreover, has a much smaller environmental footprint than heat-based copper extraction.

### CROSS REFERENCE TO RELATED APPLICATION(S)

This application claims the benefit of U.S. Provisional Application No. 63/058,544, filed Jul. 30, 2020, which is incorporated by reference as if disclosed herein in its entirety.

### STATEMENT REGARDING FEDERALLY SPONSORED RESEARCH OR DEVELOPMENT

This invention was made with government support under grant no. DGE 1644869 awarded by the National Science Foundation. The government has certain rights in the invention.

### BACKGROUND

Copper is vital for economic and societal growth since it is a conductor of heat and electricity, ductile, resistant to corrosion, and recyclable. For instance, a hybrid vehicle contains approximately 45 kilograms of copper in its wiring, motors, radiators, and brakes. The high demand for copper is coinciding with a sharp decline in the grade of copper reserves, and as a result, the cost of copper production is expected to escalate in the coming decades. Researchers project a global peak in the copper industry by the year 2050 due in part to the high costs of copper production. The development of new processing techniques of copper-containing ore is important to reduce the costs of copper production and extend the availability of new copper for several decades. The vast majority of copper reserves are in the form of chalcopyrite (CuFeS₂), and the development of hydrometallurgical technologies to convert this mineral phase into copper may have environmental benefits over existing processes.

CuFeS₂ is the most abundant mineral composite including copper found in nature, accounting for approximately 70% of global copper reserves. The two most common routes for processing these minerals are pyrometallurgy and hydrometallurgy. CuFeS₂ typically undergoes a pyrometallurgical route to produce copper. The pyrometallurgical route is characterized by high investment costs, high operating costs, and the potential release of environmentally deleterious products such as sulfur dioxide gas and arsenic. A life cycle assessment shows the extent of energy consumption, water consumption, CO₂ emission, and SO₂ emission for this processing route. Pyrometallurgical operations produce a concentrate of valuable metal sulfides, which is then smelted and refined to produce copper. However, isolating copper using heat is both harmful to the environment, e.g., releases sulfur dioxide and arsenic, and inefficient for copper extraction from lower-grade ore, which is becoming a problem as copper sources dwindle. Because of an increase in copper scarcity, there has been a recent interest in obtaining copper from lower-grade ores. This is not easily achieved via pyrometallurgy, as the concentrate produced is not clean enough to extract copper. Moreover, these heat-based techniques cannot be applied to lower-grade ore due to the reduced purity, which is becoming a problem as ideal copper sources dwindle. There is also mounting concern regarding the effects of pyrometallurgic extraction of copper on the environment, specifically the high levels of greenhouse gas emissions.

Hydrometallurgy, or the extraction of metals from their ores using aqueous solutions, has presented itself as an attractive and environmentally friendly alternative for extraction of copper from chalcopyrite. Hydrometallurgy can also be applied to lower-grade ore, as there is no concentration step required. However, there are few described hydrometallurgical methods for copper extraction from chalcopyrite that have reached commercial-scale operation.

The hydrometallurgical leaching of CuFeS₂ is generally conducted with Fe³⁺ as the oxidant, although regents such as O₂, H₂O₂, and Ag⁺ have also been studied. The diffusion of the oxidant is generally inhibited by the formation of a passivation layer on the surface of the mineral. There persists a disagreement regarding the chemical makeup of the passivation layer and the mechanism of its formation. In various media, elemental sulfur, disulfide, and polysulfide have been identified on the chalcopyrite surface, which likely contribute to the passivation. The indigenous bacteria that increase the kinetics for the oxidation of other copper-sulfides do not significantly improve the kinetics of CuFeS₂ oxidation.

Studies showed that CuFeS₂ can be converted to Cu₂S using solid copper, sulfur dioxide gas, iron, and aluminum as reducing agents. The chemical reducing agents, however, typically yield relatively low conversions and require fine CuFeS₂ particle sizes or high temperatures. An alternative approach has been developed to electrochemically reduce CuFeS₂ to Cu₂S in acidic solution. Studies have been conducted to analyze the effects of operating parameters such as acid concentration, CuFeS₂ pulp density, and temperature. In more recent studies, a sulfur passivation layer on the CuFeS₂ surface during the electrochemical reaction was proposed to cause a decrease in faradaic efficiency over reaction time. Also, experiments conducted with hydrochloric acid in a reactor divided by an anion-selective membrane showed the formation of Cu₂O as the final product, although the use of an anion-selective membrane and corrosive chloride ions increase the capital costs and electricity costs for processing. Experimental conditions that lead to different mineral products are currently not well-understood in the literature.

The refractory nature of CuFeS₂ has prohibited the widespread use of hydrometallurgical treatment in industry. Bioleaching of CuFeS₂ proceeds with a slow dissolution rate due to the formation of passivation layers on the surface of the mineral. Polysulfide, elemental sulfur, and insoluble sulfate (typically in the form of jarosite) have been identified on chalcopyrite surfaces under various conditions and have been attributed to causing the passivation. Some studies, however, disregard polysulfide as the passivating species due to its instability, and other studies disregard elemental sulfur because it is easily oxidized. The passivation is likely dependent on several factors including the oxidative potential and the involvement of microorganisms. Regardless, the slow leaching kinetics are linked to passivation and have prevented the bioleaching of CuFeS₂ on the industrial scale.

Alternative hydrometallurgical processes have been developed to mitigate the environmental impact of large-scale copper production. For instance, the dissolution of CuFeS₂ has been shown to occur rapidly under high temperatures and pressures, although such conditions may be too costly for industrial processing. The incorporation of small amounts of silver into the heap leach has been shown to alleviate the severity of passivation and improve the kinetics of copper extraction. Incorporating potassium iodide into the leaching media has shown to increase the kinetics of leaching by utilizing iodine as an oxidizing agent. Lastly, the galvanically assisted reduction of CuFeS₂ with pyrite (FeS₂) has been shown to enhance copper recovery at atmospheric pressure and relatively low temperature.

The conversion of CuFeS₂ into less refractory mineral phases prior to chemical oxidation may be a more promising hydrometallurgical route for copper recovery. As discussed above, it has been demonstrated that CuFeS₂ can be reduced to Cu₂S using copper, sulfur dioxide, iron, and aluminum as reducing agents. These reducing agents, however, tend to require fine particle sizes or high temperatures, and therefore, have not been adopted on the industrial scale. Further, to date, few studies have been conducted to assess the electrochemical treatment of CuFeS₂ by a continuous reactor.

### SUMMARY

Accordingly, some embodiments of the present disclosure relate to a method for production of copper ions. In some embodiments, the method includes providing a sample including an amount of chalcopyrite (CuFeS₂); providing an electrochemical reactor including an anode, a cathode, and an electrolyte in communication with the anode and the cathode; providing the sample to the electrochemical reactor; applying a potential between the anode and the cathode to produce a first product including cuprite (Cu₂O); and applying an oxidizing agent to the first product to oxidize the Cu₂O to produce a second product including copper ions. In some embodiments, applying a potential between the anode and the cathode to produce a first product including cuprite (Cu₂O) includes operating the electrochemical reactor at a current density less than about 50 mA/cm². In some embodiments, providing a sample including an amount of CuFeS₂ further comprises grinding the sample to have an average particle size between about 50 μm and about 110 μm.

In some embodiments, a porous separator is positioned between the sample and the anode. In some embodiments, the anode is covered by the porous separator. In some embodiments, the porous separator includes filter paper. In some embodiments, the cathode is composed of niobium, tungsten, platinum, copper, aluminum, lead, or combinations thereof. In some embodiments, the anode is composed of niobium, tungsten, platinum, copper, aluminum, lead, or combinations thereof. In some embodiments, the cathode further comprises a bed of cathode material particles. In some embodiments, the ratio of cathode surface area (cm²) to electrochemical reactor volume (mL) is above about 0.15. In some embodiments, the oxidizing agent includes a source of Fe³⁺ ions.

Some embodiments of the present disclosure relate to a system for production of copper ions. In some embodiments, the system includes a source of chalcopyrite (CuFeS₂); an electrochemical reactor in communication with the source of CuFeS₂, the electrochemical reactor including an anode covered by a porous separator; a cathode; an electrolyte in communication with the anode and the cathode; and at least one product outlet, a first product stream in communication with the at least one product outlet, the first product stream including cuprite (Cu₂O); a source of Fe³⁺ ions in communication with the first product stream; and a second product stream in communication with the first product stream, the second product stream including copper ions.

In some embodiments, the ratio of cathode surface area (cm²) to electrochemical reactor volume (mL) is above about 0.15. In some embodiments, the cathode is composed of niobium, tungsten, platinum, copper, aluminum, lead, or combinations thereof. In some embodiments, the anode is composed of niobium, tungsten, platinum, copper, aluminum, lead, or combinations thereof. In some embodiments, the cathode further comprises a bed of cathode material particles. In some embodiments, the electrochemical reactor is operated at a current density less than about 50 mA/cm².

Some embodiments of the present disclosure relate to a system for production of copper ions. In some embodiments, the system includes a source of chalcopyrite (CuFeS₂); a source of Fe³⁺ ions; an electrochemical reactor in communication with the source of CuFeS₂ and the source of Fe³⁺ ions, the electrochemical reactor including an anode; a cathode; an electrolyte in communication with the anode and the cathode; a potentiostat; and at least one product outlet, and, a product stream in communication with the at least one product outlet, the product stream including copper ions, wherein the ratio of cathode surface area (cm²) to reactor volume (mL) is above about 0.15, and the potentiostat operates the electrochemical reactor at a current density less than about 50 mA/cm². In some embodiments, a porous separator is positioned to isolate the anode from contact with the CuFeS₂. In some embodiments, the anode is covered by at least one layer of filter paper. In some embodiments, the cathode is composed of niobium, tungsten, platinum, copper, aluminum, lead, or combinations thereof. In some embodiments, the anode is composed of niobium, tungsten, platinum, copper, aluminum, lead, or combinations thereof. In some embodiments, the cathode further comprises a bed of cathode material particles.

### BRIEF DESCRIPTION OF THE DRAWINGS

The drawings show embodiments of the disclosed subject matter for the purpose of illustration. However, it should be understood that the present application is not limited to the precise arrangements and instrumentalities shown in the drawings, wherein:

FIG. 1A is a schematic representation of a system for production of copper ions according to some embodiments of the present disclosure;

FIG. 1B is a schematic representation of a system for production of copper ions according to some embodiments of the present disclosure;

FIG. 2 is a graph showing the percent of Fe and Cu released into solution from CuFeS₂ during the progression of an electrochemical reaction according to some embodiments of the present disclosure;

FIG. 3 is an image comparing solid residue products after 5 hours of operation of an electrochemical reactor according to some embodiments of the present disclosure;

FIG. 4 portrays graphs showing x-ray diffraction (XRD) results for mineral products after processing by an electrochemical reactor;

FIG. 5 is a chart of a method for production of copper ions according to some embodiments of the present disclosure;

FIG. 6 portrays a graph showing XRD results for mineral products after processing by an electrochemical reactor according to some embodiments of the present disclosure;

FIG. 7A portrays a graph showing x-ray photoelectron spectroscopy (XPS) analysis of mineral products by an electrochemical reactor;

FIG. 7B portrays a graph showing XPS analysis of mineral products by an electrochemical reactor according to some embodiments of the present disclosure;

FIG. 8A portrays a graph showing XPS analysis of mineral products by an electrochemical reactor;

FIG. 8B portrays a graph showing XPS analysis of mineral products by an electrochemical reactor according to some embodiments of the present disclosure;

FIG. 9 portrays a graph showing release of copper ions into solution upon oxidation of the mineral products with iron (III) sulfate;

FIGS. 10A and 10B show schematic representations of electrochemical conversion of chalcopyrite to copper ions according to some embodiments of the present disclosure;

FIG. 11 shows a fixed bed electrochemical reactor including a covered anode according to some embodiments of the present disclosure;

FIG. 12 portrays a graph showing release of iron ions from chalcopyrite;

FIG. 13 portrays a graph showing the faradaic efficiencies of the electrochemical reduction of chalcopyrite;

FIG. 14 portrays graphs showing the effect of current density on the conversion of chalcopyrite and the faradaic efficiency of the applied current densities;

FIG. 15 portrays graphs showing XRD spectra for a chalcopyrite concentrate and the reaction products;

FIG. 16 portrays graphs showing the effect of electrode surface area on the conversion of chalcopyrite and the associated faradaic efficiencies;

FIG. 17 portrays graphs showing the effect of an exposed anode surface on the conversion of chalcopyrite and subsequent oxidation to extract copper ions;

FIGS. 18A and 18B portray graphs showing continuous single-pass conversion of chalcopyrite (FIG. 18A) and the associated faradaic efficiencies (FIG. 18B) according to some embodiments of the present disclosure; and

FIGS. 19A and 19B portray graphs showing continuous multi-pass conversion of chalcopyrite (FIG. 19A) and the associated Faradaic efficiencies (FIG. 19B) according to some embodiments of the present disclosure.

### DETAILED DESCRIPTION

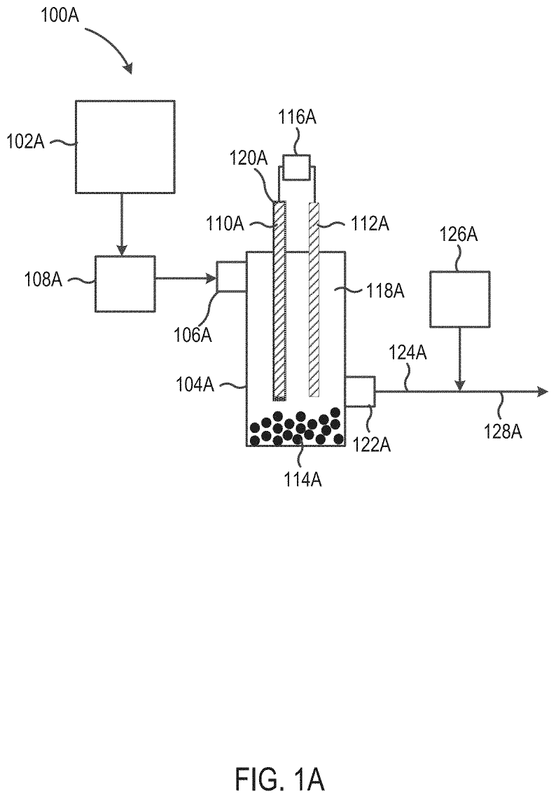

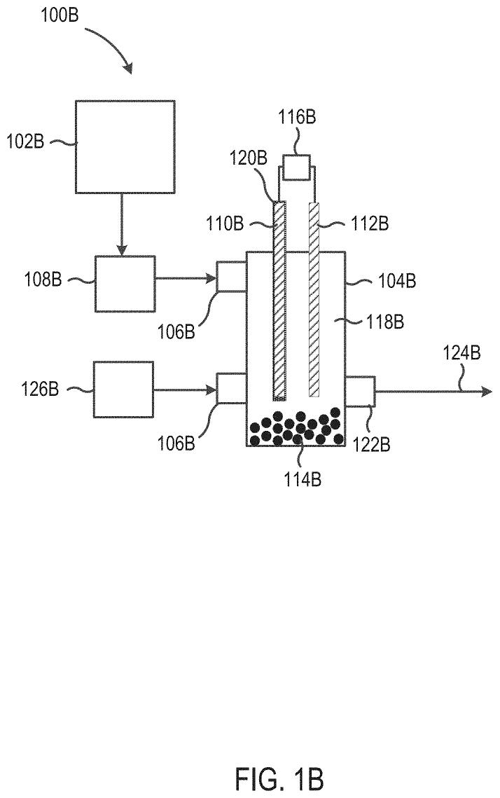

Referring now to FIGS. 1A-1B, some aspects of the disclosed subject matter are directed to a system, e.g., 100A and 100B, for electrochemical reduction of mineral composite including metal to a material more suited to chemical oxidation. The material more suited to chemical oxidation can then be further oxidized to produce a desired product, such as a concentration of metal ions. In some embodiments, the mineral composite includes copper, iron, nickel, cobalt, or combinations thereof. In some embodiments, the mineral composite includes chalcopyrite (CuFeS₂). In some embodiments, the methods of the present disclosure extract copper, nickel, cobalt, or combinations thereof, e.g., copper, nickel, or cobalt ions.

Referring specifically to FIG. 1A, some embodiments of the present disclosure include a system 100A. In some embodiments, system 100A includes a source of mineral composite 102A. In some embodiments, source 102A includes raw material that includes the mineral composite. In some embodiments, source 102A includes substantially homogenous mineral composite, i.e., substantially free of impurities, inert materials, etc. The exemplary embodiment shown in FIG. 1A produces from CuFeS₂ a material more suited to chemical oxidation, cuprite (Cu₂O), which can be further oxidized to produce copper ions. Thus, in some embodiments, system 100A includes a source 102A of CuFeS₂. In some embodiments, system 100A includes an electrochemical reactor 104A in communication with source 102A, e.g., with the source of CuFeS₂. In some embodiments, electrochemical reactor 104A is configured to receive a sample from source 102A for processing in the electrochemical reactor. In some embodiments, the sample is provided to electrochemical reactor 104A via one or more inputs 106A. In some embodiments, the sample is pre-processed before being provided to electrochemical reactor 104A, e.g., via pre-processing module 108A. In some embodiments, pre-processing module 108A includes any component or combination of components suitable to prepare a sample of mineral composite for electrochemical conversion in electrochemical reactor 104A. In some embodiments, pre-processing module 108A includes one or more grinders, separators, heaters, coolers, etc., and combinations thereof.

Still referring to FIG. 1A, in some embodiments, electrochemical reactor 104A includes an anode 110A and a cathode 112A. In some embodiments, anode 110A is composed of niobium, tungsten, platinum, copper, aluminum, lead, or combinations thereof. In some embodiments, cathode 112A is composed of niobium, tungsten, platinum, copper, aluminum, lead, or combinations thereof. In some embodiments, electrochemical reactor 104A includes a bed 114A of cathode material particles. In some embodiments, cathode 112A surface area is about 1 cm², 2 cm², 4 cm², 8 cm², etc. In some embodiments, anode 110A surface area is about 1 cm², 2 cm², 4 cm², 8 cm², etc.

In some embodiments, the volume of electrochemical reactor 104A is any suitable size to accommodate the amount of mineral composite sample to achieve the desired product output, as will be discussed in greater detail below. In some embodiments, the ratio of cathode 112A surface area (cm²) to electrochemical reactor 104A volume (mL) is above about 0.01. In some embodiments, the ratio of cathode 112A surface area (cm²) to electrochemical reactor 104A volume (mL) is above about 0.015. In some embodiments, the ratio of cathode 112A surface area (cm²) to electrochemical reactor 104A volume (mL) is above about 0.1. In some embodiments, the ratio of cathode 112A surface area (cm²) to electrochemical reactor 104A volume (mL) is above about 0.15. In some embodiments, the ratio of cathode 112A surface area (cm²) to electrochemical reactor 104A volume (mL) is above about 0.2.

In some embodiments, electrochemical reactor 104A includes a potentiostat 116A in communication with anode 110A and cathode 112A. In some embodiments, electrochemical reactor 104A is operated at a current density less than about 300 mA/cm². In some embodiments, electrochemical reactor 104A is operated at a current density less than about 100 mA/cm². In some embodiments, electrochemical reactor 104A is operated at a current density less than about 50 mA/cm². In some embodiments, electrochemical reactor 104A is operated at a current density less than about 10 mA/cm². In some embodiments, electrochemical reactor 104A includes an electrolyte 118A in communication with anode 110A and cathode 112A. Electrolyte 118A can be any suitable electrolyte for use with the particular materials used anode 110A and cathode 112A.

In some embodiments, electrochemical reactor 104A includes a porous separator 120A. In some embodiments, porous separator 120A is configured and positioned within electrochemical reactor 104A to limit contact between the sample of the mineral composite and anode 110A. In some embodiments, porous separator 120A is configured and positioned within electrochemical reactor 104A to prevent contact between the sample of the mineral composite and anode 110A. In some embodiments, porous separator 120A includes one or more layers positioned on anode 110A. In some embodiments, porous separator 120A includes one or more layers covering one or more surfaces of anode 110A. In some embodiments, porous separator 120A includes one or more layers covering all surfaces of anode 110A. In some embodiments, porous separator 120A includes one or more layers including filter paper.

Still referring to FIG. 1A, in some embodiments, electrochemical reactor 104A includes at least one product outlet 122A. In some embodiments, system 100A includes a first product stream 124A in communication with at least one product outlet 122A. In some embodiments, first product stream 124A includes the material more suited to chemical oxidation, e.g., Cu₂O. In some embodiments, system 100A includes a source of Fe³⁺ ions 126A in communication with first product stream 124A. In some embodiments, source 126A is any suitable composition to provide Fe³⁺ ions that oxidize one or more components in first product stream 124A and produce a desired product, intermediate, or combination thereof. In some embodiments, source 126A includes iron (III) sulfate hydrate. In some embodiments, system 100 includes a second product stream 128A in communication with first product stream 124A. In some embodiments, second product stream 128A is positioned and configured to remove from system 100A a product evolved from a reaction of first product stream 124A with source 126A. In some embodiments, second product stream 128A includes copper ions.

Without wishing to be bound by theory, system 100A facilitates electrochemical conversion of mineral composites to less refractory mineral phases, e.g., conversion of CuFeS₂ through a chalcocite (Cu₂S) intermediate. Specifically, CuFeS₂ reacts at cathode 112A of electrochemical reactor 104A to release iron and forms an intermediate Cu₂S mineral phase according to the following Reaction 1:

2CuFeS₂+6H⁺+2e⁻→Cu₂S+2Fe²⁺+3H₂S [1]

However, allowing Cu₂S to contact anode 110A leads to the formation of a covellite (CuS) mineral phase according to the following Reaction 2:

Cu₂S→CuS+Cu²⁺+2e⁻ [2]

Covering anode 110A limits or prevents the mineral from anode contact, limiting conversion of Cu₂S to CuS according to Reaction 2. Instead, a slower reaction between Cu₂S and cathode 112A leads to the formation of Cu₂O mineral phase according to Reaction 3:

2e⁻+Cu₂S+2H⁺+O₂→2Cu₂O+H₂S [3]

Covering anode 110A showed minimal effect on the cell potential or release of iron ions into electrochemical reactor 104A. The surface of the minerals showed no significant passivation from elemental sulfur. Cu₂O is more readily oxidized than CuS. Thus, copper ions are extracted from the Cu₂O by an Fe³⁺ oxidant according to Reaction 4:

2Cu₂O+8Fe³⁺→4Cu²⁺+8Fe²⁺+O₂ [4]

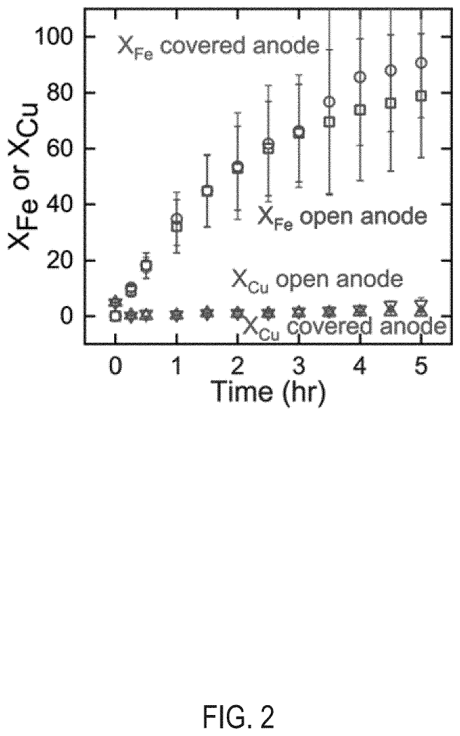

Referring now to FIG. 2, an exemplary electrochemical reactor consistent with the embodiments of the present disclosure, e.g., electrochemical reactor 104A from system 100A discussed above, was prepared to convert CuFeS₂ to copper ions. The fractions of Fe ions released into solution from CuFeS₂ during the progression of the electrochemical reactions are shown. The results show that the fraction of Fe released from CuFeS₂ trends towards completion after approximately five hours, whereas an insignificant fraction of Cu is released. The removal of Fe indicates the conversion of CuFeS₂ into mineral phases with less iron. Covering the anode shows no discernible effect on Fe release. Despite the high degree of experimental variability, the AAS data for each individual experiment correlated well with the XRD and XPS data. Therefore, correlations were drawn between the extent of CuFeS₂ conversion and the composition of the solid products formed.

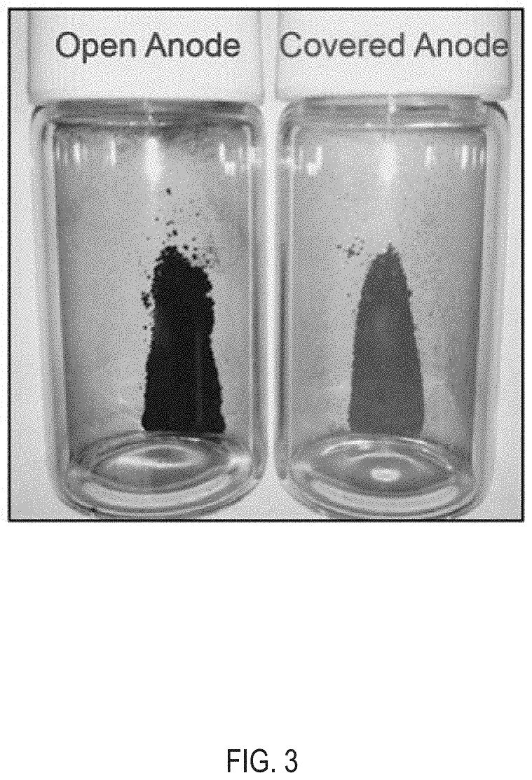

FIG. 3 shows a picture taken of the products of the electrochemical reaction when an Pb anode was open to the reactor as well as when it was covered. Although the release of ions and cell potentials were similar for the two electrode arrangements, the products of the reactions were different. After a duration of five hours, experiments with the uncovered Pb anode yielded a fine black powder, whereas experiments with a covered Pb anode yielded a fine red-brown powder. For shorter durations, the appearance of the products was similar for the two electrode arrangements.

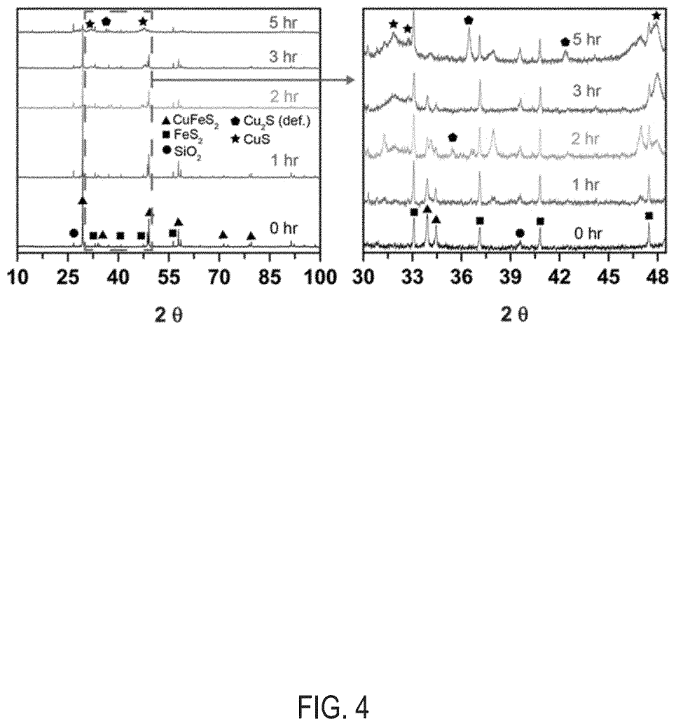

X-ray Powder Diffraction (XRD) was performed to characterize the solid residues of each chalcopyrite reduction experiment. FIG. 4 shows examples of the mineral products after 0, 1, 2, 3, and 5 hours for a Pb cathode and an uncovered Pb anode. The XRD peaks of the un-reacted chalcopyrite mineral (0 hr) can be attributed to CuFeS₂ (chalcopyrite, Reference code: 00-037-0471), FeS₂ (pyrite, Reference code: 00-042-1340) and SiO₀₂ (quartz, Reference code: 00-033-1161). The most intense peaks at the position of 2θ=29.4°, 48.7°, 49.0° and 57.9° belong to CuFeS₂, which shows that the majority of the solid is chalcopyrite and is consistent with the mineralogy analyzed by the supplier in Table 2. The XRD patterns of the electrochemically reduced products indicate the presence of Cu₂₉S₁₆ (Roxbyite, Reference code: 00-023-0958), Cu₃₁S₁₆ (Djurleite, Reference code: 00-023-0959), CuS (Covellite, Reference code: 01-078-2121) and Cu₂O (Cuprite, Reference code: 01-078-2076).

In some embodiments, system 100A is operated continuously, semi-continuously, as a batch system, as a semi-batch system, or combinations thereof. In some embodiments, the residence time of reactants in electrochemical reactor 104A is about 10 s, 15 s, 20 s, 25 s, 30 s, 35 s, 40 s, 45 s, 50 s, 55 s, 60 s, 2 minutes, 3 minutes, 4 minutes, 5 minutes, 10 minutes, 15 minutes, 20 minutes, 25 minutes, 30 minutes, 35 minutes, 40 minutes, 45 minutes, 50 minutes, 55 minutes, 60 minutes, or greater than 60 minutes. In some embodiments, conditions in electrochemical reactor 104A are configured according to Table 1.

TABLE 1
Reactor Conditions

| | Lower Concentration | Upper Concentration |
|---|---|---|
| Species in electrolyte | Range | Range |
| Sulfuric Acid | 0.1M | 5.0M |
| Chalcopyrite Concentrate | 10 g/L | 1000 g/L |
| Iron ions | 0.0M | 5.0M |
| Copper ions | 0.0M | 1.0M |

In some embodiments, iron concentrations of 0.1M are achieved for loading of 20 g/L of CuFeS₂. Without wishing to be bound by theory, the ratio of mineral to copper product is dependent on the electrochemical reactor design (for example, the choice of anode and cathode materials). The ratio and type of mineral (covellite, chalcocite, roxbyite, etc.) will depend on other factors.

Referring now to FIG. 1B, an alternative embodiment of system 100A discussed above is shown as system 100B. The exemplary alternative embodiment shown in FIG. 1B is also configured for the production of copper ions. In some embodiments, system 100B includes a source of CuFeS₂ 102B and a source of Fe³⁺ ions 126B. In some embodiments, source 126B includes iron (III) sulfate hydrate. In some embodiments, system 100B includes an electrochemical reactor 104B in communication with the source 102B and source 126B. In some embodiments, electrochemical reactor 104B is configured to receive input streams from source 102B and source 126B for processing in the electrochemical reactor. In some embodiments, the streams are provided to electrochemical reactor 104B via one or more inputs 106B. In some embodiments, the sample is pre-processed before being provided to electrochemical reactor 104B, e.g., via pre-processing module 108B. In some embodiments, pre-processing module 108B includes any component or combination of components suitable to prepare a sample of mineral composite for electrochemical conversion in electrochemical reactor 104B. In some embodiments, pre-processing module 108B includes one or more grinders, separators, heaters, coolers, etc., and combinations thereof.

As discussed above, in some embodiments, electrochemical reactor 104B includes an anode 110B, a cathode 112B, and an electrolyte 118B in communication with anode 110B and cathode 112B. In some embodiments, anode 110B is composed of niobium, tungsten, platinum, copper, aluminum, lead, or combinations thereof. In some embodiments, cathode 112B further comprises a bed 114B of cathode material particles. In some embodiments, cathode 112B is composed of niobium, tungsten, platinum, copper, aluminum, lead, or combinations thereof. In some embodiments, the ratio of cathode 112B surface area (cm²) to electrochemical reactor 104B volume (mL) is above about 0.01. In some embodiments, the ratio of cathode 112B surface area (cm²) to electrochemical reactor 104B volume (mL) is above about 0.015. In some embodiments, the ratio of cathode 112B surface area (cm²) to electrochemical reactor 104B volume (mL) is above about 0.1. In some embodiments, the ratio of cathode 112B surface area (cm²) to electrochemical reactor 104B volume (mL) is above about 0.15. In some embodiments, the ratio of cathode 112B surface area (cm²) to electrochemical reactor 104B volume (mL) is above about 0.2. Electrolyte 118B can be any suitable electrolyte for use with the particular materials used anode 110B and cathode 112B.

In some embodiments, electrochemical reactor 104B includes a porous separator 120B. In some embodiments, porous separator 120B is configured and positioned within electrochemical reactor 104B to limit contact between the sample of the mineral composite and anode 110B. In some embodiments, porous separator 120B is configured and positioned within electrochemical reactor 104B to prevent contact between the sample of the mineral composite and anode 110B. In some embodiments, a porous separator 120B is positioned to isolate anode 110B from contact with the CuFeS₂. In some embodiments, porous separator 120B includes one or more layers positioned on anode 110B. In some embodiments, porous separator 120B includes one or more layers covering one or more surfaces of anode 110B. In some embodiments, porous separator 120B includes one or more layers covering all surfaces of anode 110B. In some embodiments, porous separator 120B includes one or more layers including filter paper.

In some embodiments, electrochemical reactor 104B includes a potentiostat 116B. In some embodiments, potentiostat 116B operates electrochemical reactor 104B at a current density less than about 300 mA/cm². In some embodiments, potentiostat 116B operates electrochemical reactor 104B at a current density less than about 100 mA/cm². In some embodiments, potentiostat 116B operates electrochemical reactor 104B at a current density less than about 50 mA/cm². In some embodiments, potentiostat 116B operates electrochemical reactor 104B at a current density less than about 10 mA/cm².

In some embodiments, electrochemical reactor 104B includes at least one product outlet 122B. In some embodiments, system 100B includes a product stream 124B in communication with product outlet 122B. In this exemplary embodiment, product stream 124B includes a concentration of copper ions. As discussed above, CuFeS₂ from source 102B reacts at cathode 112B of electrochemical reactor 104B to release iron and form an intermediate Cu₂S mineral phase. The intermediate Cu₂S mineral phase is then converted at cathode 112B to form a Cu₂O mineral phase. The presence of Fe³⁺ ions from source 126B then oxidize the Cu₂O mineral phase to copper ions, which can be removed from system 100B via product stream 124B. In some embodiments, system 100B is operated continuously, semi-continuously, as a batch system, as a semi-batch system, or combinations thereof. In some embodiments, the residence time of reactants in electrochemical reactor 104B is about 10 s, 15 s, 20 s, 25 s, 30 s, 35 s, 40 s, 45 s, 50 s, 55 s, 60 s, 2 minutes, 3 minutes, 4 minutes, 5 minutes, 10 minutes, 15 minutes, 20 minutes, 25 minutes, 30 minutes, 35 minutes, 40 minutes, 45 minutes, 50 minutes, 55 minutes, 60 minutes, or greater than 60 minutes.

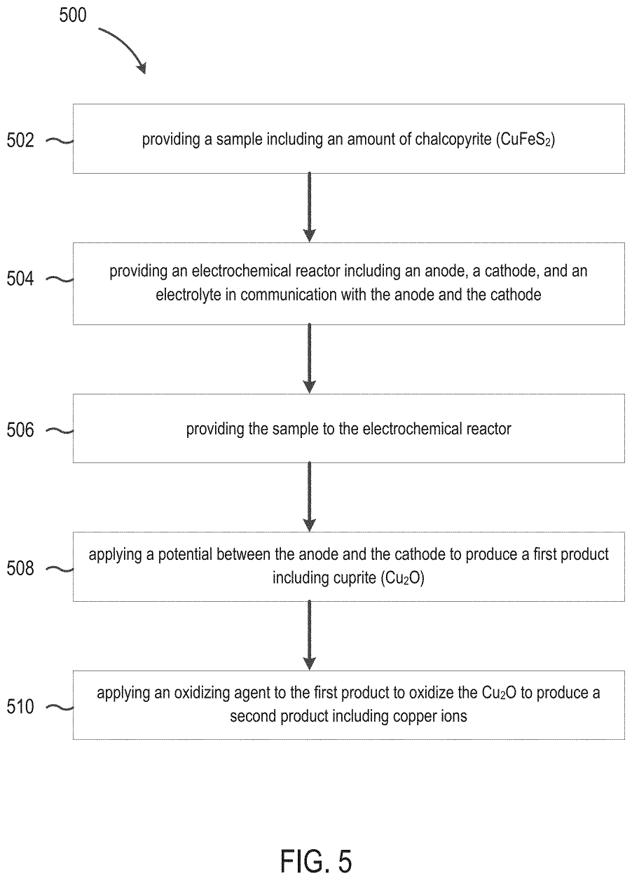

Referring now to FIG. 5, some aspects of the disclosed subject matter are directed to a method 500 for the production of a desired product via electrochemical reduction of mineral composite including metal to a material more suited to chemical oxidation. In some embodiments, the material more suited to chemical oxidation is further oxidized to produce a desired product, such as a concentration of metal ions. In some embodiments, method 500 is for production of copper ions. At 502, a sample including an amount of mineral composite is provided. In some embodiments, the mineral composite includes CuFeS₂. At 504, an electrochemical reactor is provided. As discussed above, in some embodiments, the electrochemical reactor includes including an anode, a cathode, and an electrolyte in communication with the anode and the cathode. In some embodiments, the anode is composed of niobium, tungsten, platinum, copper, aluminum, lead, or combinations thereof. In some embodiments, the cathode is composed of niobium, tungsten, platinum, copper, aluminum, lead, or combinations thereof. In some embodiments, the cathode further comprises a bed of cathode material particles. In some embodiments, a porous separator is positioned between the sample and the anode. In some embodiments, the anode is covered by the porous separator. In some embodiments, the porous separator includes filter paper. In some embodiments, the ratio of cathode surface area (cm²) to electrochemical reactor volume (mL) is above about 0.01. In some embodiments, the ratio of cathode surface area (cm²) to electrochemical reactor volume (mL) is above about 0.015. In some embodiments, the ratio of cathode surface area (cm²) to electrochemical reactor volume (mL) is above about 0.1. In some embodiments, the ratio of cathode surface area (cm²) to electrochemical reactor volume (mL) is above about 0.15. In some embodiments, the ratio of cathode surface area (cm²) to electrochemical reactor volume (mL) is above about 0.2.

At 506, the sample is provided to the electrochemical reactor. In some embodiments, the sample is first ground to a desired particle size. In some embodiments, the sample is ground to have an average particle size between about 50 μm and about 110 μm. At 508, a potential is applied between the anode and the cathode to produce a first product. In some embodiments, the electrochemical reactor is operated at a current density less than about 300 mA/cm². In some embodiments, the electrochemical reactor is operated at a current density less than about 100 mA/cm². In some embodiments, the electrochemical reactor is operated at a current density less than about 50 mA/cm². In some embodiments, the electrochemical reactor is operated at a current density less than about 10 mA/cm². In some embodiments, the first product is more suited to chemical oxidation and is further oxidized to produce a desired product. In some embodiments, the first product includes Cu₂O. At 510, an oxidizing agent is applied to the first product to oxidize the first product, e.g., the Cu₂O, to produce a second product. In some embodiments, the oxidizing agent includes a source of Fe³⁺ ions. In some embodiments, the oxidizing agent includes iron (III) sulfate hydrate. In some embodiments, the second product includes copper ions.

### Methods

Electrochemical reactors consistent with embodiments of the present disclosure were prepared. The electrochemical reductions were tracked by AAS. The solid products formed are then characterized by XRD and XPS.

Chalcopyrite mineral concentrate was provided by Freeport McMoran. It was analyzed by the supplier with energy dispersion X-ray diffraction to have the following composition:

TABLE 2
Mineralogy of mineral concentrate

| Mineral | Chemical Formula | Percent |
|---|---|---|
| Chalcopyrite | CuFeS₂ | 78.3 |
| Pyrite | FeS₂ | 12.9 |
| K-feldspar | KAlSi₃O₈ | 2.9 |
| Plagioclase | NaAlSi₃O₈ | 2.9 |
| Quartz | SiO₂ | 2.2 |
| Molybdenite | MoS₂ | 0.85 |

The mineral concentrate used in experimentation was sieved (−140+270 mesh) to confine the size distribution of the particles to be within 53-106 μm. The electrochemical conversion experiments were conducted in an undivided batch reactor including 50.0 mL of 1.00 M H₂SO₄ and 20.0 g/L of the sieved concentrate. The reactor was stirred constantly at 300 rpm and utilized a two-electrode configuration. Lead foil (Alfa Aesar) was used as the anode material, and for some trials, the lead anode was covered with Whatman filter paper of pore size 2.5 μm (Sigma Aldrich) to prevent mineral contact. Either lead foil or copper foil (Alfa Aesar) was used as the cathode material. Kapton tape (McMaster Carr) was used to confine the area of the electrodes to be 1 cm² on either face in solution. An IviumnStat potentiostat was used to apply a constant current density of 0.3 A/cm² between the electrodes while continuously measuring the cell potential. The current was chosen to achieve a high conversion of CuFeS₂ for X-ray diffraction (XRD) and X-ray photoelectron spectroscopy (XPS) analysis.

The concentrations of Fe and Cu ions within the reactor were measured to probe the reactions over time. Upon the application of current, samples of 0.2 mL were taken from the reactor at time points of 0, 15, 30, 60, 90, 120, 150, and 180 minutes. The solid minerals within the samples were settled by centrifugation at 6000 rpm for approximately one minute. The samples were subsequently diluted with de-ionized (DI) water to lower ion concentrations to within the range of 0-4 ppm. Concentrations of the samples were measured using a Thermo Scientific iCE 30000 Series atomic absorption spectrometer (AAS). Known standards ranging from 0-4 ppm were used to construct a linear five-point calibration curve (R²>0.99) and were measured immediately before the collected samples. The fractions of Fe and Cu ions released from CuFeS₂ into solution were calculated with the following Equations 1 and 2:

$$\begin{matrix}{X}_{F e} = \frac{{c}_{F e}}{{P}_{CUFeS 2} {W}_{CuFe S 2} {W}_{F e}} \times 100 & [ 1 ] \\ {X}_{C u} = \frac{{c}_{Cu}}{{P}_{CUFeS 2} {W}_{CuFe S 2} {W}_{Cu}} \times 100 & [ 2 ]\end{matrix}$$

where X_{Fe}, c_{Fe}, P_{CuFeS2}, W_{CuFeS2}, and W_{Fe} represent the percent of Fe²⁺ released, the measured concentration of Fe²⁺ in solution, the pulp density of mineral concentrate initially placed in solution, the weight fraction of chalcopyrite in the mineral concentrate, and the weight fraction of Fe in CuFeS₂, respectively. It was assumed that pyrite (FeS₂) did not release Fe ions into solution. For some trials, a fraction of the mineral products were oxidized with iron (III) sulfate hydrate (Sigma Aldrich) to measure the release of Cu²⁺ ions from the products of the electrochemical reactor.

The mineral products of the electrochemical reactions were filtered from solution with a Rocker 300 vacuum pump and were subsequently allowed to air-dry for one to five hours. The solid samples were then stored in pure nitrogen or argon gas to minimize oxidation in air. The mineral products were placed on a zero-diffraction plate made of silicon crystal (MTI corporation). The solid mineral product powder was adhered in place with Apiezon grease to ensure a flat surface, consistent across the samples. A PANalytical XPert3 Powder X-ray diffractor with filtered Empyrean Cu K_{α} radiation (λ=0.15418 nm), operating at a tube voltage of 45 kV and current of 40 mA, was used to analyze the bulk composition of the mineral products. The mineral samples were scanned continuously in the range of 10-100° with a step size of 0.002°, on a spinning sample plate with a revolution time of 2.0 s. The intensity was recorded by a PIXcel1D detector. The XRD data were analyzed by Rietveld refinement using the software MAUD to estimate the quantitative compositions of the solids.

The mineral products, which had been protected from long term exposure to oxygen via storage in argon or nitrogen gas, were placed on PELCO Tabs™ carbon tape (Ted Pella, Inc.) in order to ensure a flat, uniform surface for XPS analysis. The elemental state of the mineral surface was measured by X-ray photoelectron spectroscopy (XPS) with a Phi 5500 XPS spectrophotometer equipped with a monochromatic Al K_{α} source (photon energy 1486 eV, work function 3.41, scale factor 20.0119.) Scans for S 2p3, S 2s and Cu 2p3 were recorded for the samples. The charge of each sample was corrected based on a C 1s scan for adventitious carbon. A scan rate of 655 ms per step was employed with 0.025 eV per step, and multiple scans were used when needed for greater clarity. The experimental data were fit using XPSPEAK 4.1 software in order to determine the fraction of each elemental state.

Table 3 shows the composition of the mineralogy estimated from the Rietveld refinement throughout the progression of the reactions. The fraction of CuFeS₂ in the mineralogy diminished over time, at a rate which is consistent with the release of Fe ions into solution as tracked by the AAS data. Without wishing to be bound by theory, the FeS₂ and SiO₂ quantities did not significantly change, indicating that these minerals were unreactive during the electrochemical processing.

TABLE 3
Mineral composition determined from
Rietveld refinement of the XRD data

| Time | 0 hr | 2 hr | 3 hr | 5 hr | 3 hr | 5 hr |
|---|---|---|---|---|---|---|
| Anode | | Pb | Pb | Pb | Covered Pb | Covered Pb |
| CuFeS₂ | 85 | 45 | 32 | 6 | 50 | 2 |
| FeS₂ | 10 | 11 | 11 | 9 | 10.5 | 10 |
| SiO₂ | 5 | 6.5 | 6.5 | 7 | 5 | 4 |
| Cu₂₉S₁₆ | / | 30 | 3 | 11 | 34.5 | / |
| Cu₃₁S₁₆ | / | / | / | 23 | / | 3 |
| CuS | / | 7.5 | 47.5 | 41.5 | / | / |
| Cu₂O | / | / | / | 2.5 | / | 82 |

For the electrode arrangement of a Pb cathode and an open Pb anode, the estimated compositions show that Cu₂S (with some defects) was the primary product after a duration of two hours and that CuS was the primary product after a duration of five hours. Without wishing to be bound by theory, Reaction 1 above shows that contact between CuFeS₂ and the cathode material leads to the formation of Cu₂S on the particle surface. Reaction 2 above shows that subsequent contact between Cu₂S and the anode leads to the formation of CuS on the particle surface and the removal of a Cu²⁺ ion. Reaction 5 shows the well-established reaction that Cu²⁺ ions precipitate as CuS in the presence of H₂S with fast kinetics.

Cu²⁺+H₂S→CuS+2H⁺ [⁵]

As a consequence of Reaction 5, few Cu²⁺ ions were measured in solution, as shown in FIG. 2.

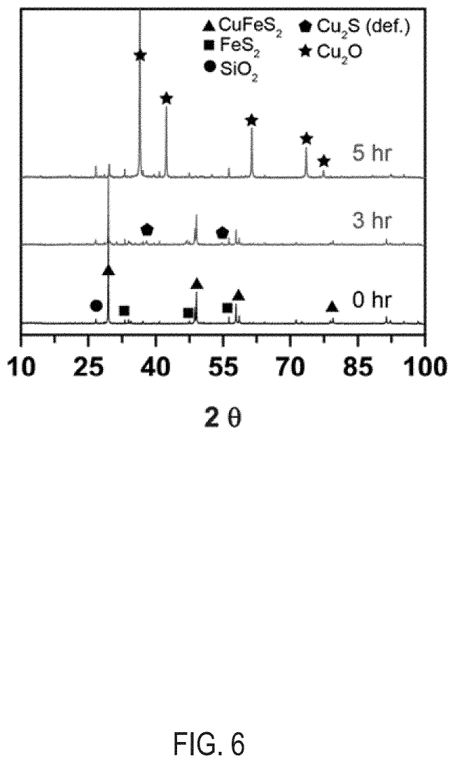

Referring now to FIG. 6, examples of the mineral products after 0, 3, and 5 hours for a Pb cathode and a covered Pb anode are shown. The covered Pb anode prevented Reaction 2, and by extension, Reaction 5. As a consequence, there was a different reaction scheme, including the formation of different products. The XRD patterns qualitatively show the predominant formation of Cu₂O after a duration of five hours.

The Rietveld refinement technique was employed to estimate the compositions of the mineral products, and the results are shown in Table 3. The compositions show that Cu₂S was the primary product after 3 hours and that Cu₂O was the primary product after 5 hours.

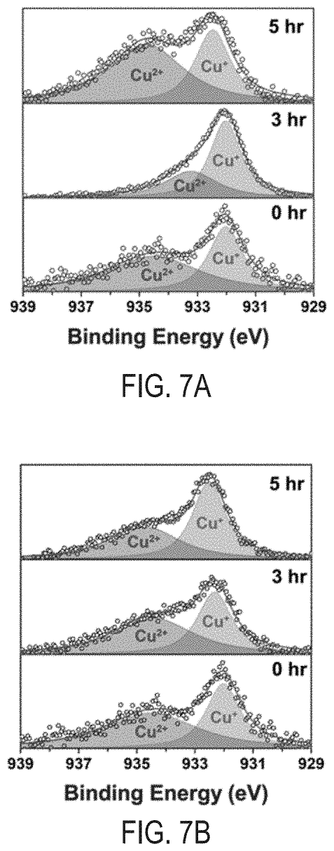

X-ray photoelectron spectroscopy (XPS) was performed to determine elemental states of copper and sulfur on the minerals. FIGS. 7A-7B show the Cu 2p^{3/2} spectra present two partially superimposed peaks at approximately 932.0˜932.4 eV and 933.6˜934.4 eV. The higher binding energy peaks correspond to Cu²⁺ ions while the peaks with lower binding energy belong to Cu⁺ ions. FIG. 7A shows that the dominant oxidation state of copper shifts from Cu⁺ to Cu²⁺ between 3 hours and 5 hours, which is consistent with transition from Cu₂S (with defects) to CuS. FIG. 7B shows that the dominant oxidation state of copper is consistently Cu⁺, which agrees with the transition from Cu₂S (with defects) to Cu₂O.

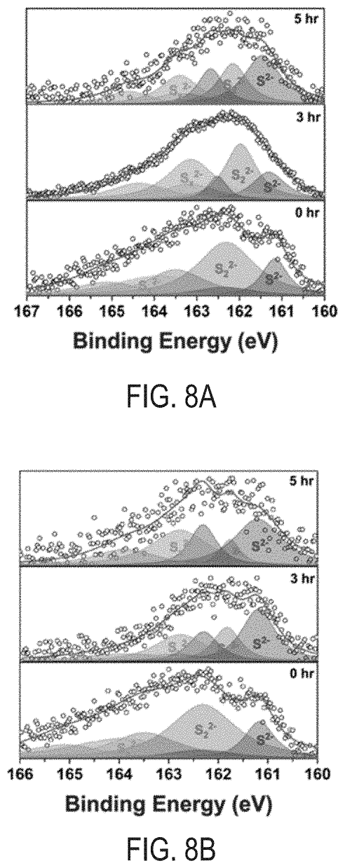

Referring now to FIGS. 8A-8B, the spectra of sulfur 2p were also studied. The sulfur 2p peaks were fitted by two sets, including 2p^{3/2} and 2p^{1/3} with an energy separation of 1.18 eV. The S 2p^{3/2} set was further divided into three components: mono-sulfide peaks (lowest binding energy), disulfide peaks (˜162 eV) and polysulfide peaks (highest binding energy). The high polysulfide ratio was due to the major presence of a complex sulfur structure such as Cu₂₉S₁₆ and Cu₃₁S₁₆ at the surface of the solid particles.

FIG. 8A shows the XPS analysis of the mineral products for sulfur when the Pb anode is open to the reactor, allowing direct contact of the particles with the anode surface. The fraction of the mono-sulfide species increased between 3 hours and 5 hours, which is consistent with the transition from Cu₂S (with defects) to CuS. Additionally, the mineral samples exhibited an initial increase and then decrease in the polysulfide ratio, which is consistent with the generation and depletion of Cu₂₉S₁₆. By contrast, FIG. 8B shows the XPS analysis of the mineral products for sulfur when the Pb anode is covered. The mineral products for this electrode arrangement do not display any increasing mono-sulfide ratio and show a sustained increase in the polysulfide ratio. Without wishing to be bound by theory, the XPS data therefore reinforced the conclusion that CuS was produced by direct contact with the anode.

The atom ratio of S/Cu on the surface of the particles was calculated from the relative peak areas of the two elements. The results do not indicate that there is a passivation layer of elemental sulfur on the surface of the products, as has been postulated. Rather, the XPS spectra revealed the outer layer of the solids to be similar to the reaction products, which is consistent with a shrinking core model. When the Pb anode was open to the reactor, the S/Cu ratio on the surface of the mineral product was approximately equal to one, which is consistent with the formation of CuS. When the Pb anode was covered, the S/Cu ratio approached values significantly less than one, which is consistent with the formation of Cu₂O. The S/Cu ratio did not reach zero due to the measurement of sulfur on the inert FeS₂ phases within the mineral concentrate. The presence of iron on the surface could not be measured with significant intensity, which indicates that CuFeS₂ is present in the bulk of the particle rather than the surface. A summary of the analysis of the XPS data is shown in Table 4.

TABLE 4
XPS data of the mineral products over the progression of the
electrochemical reaction for the two electrode configurations

| Time | 0 hr | 3 hr | 5 hr | 3 hr | 5 hr |
|---|---|---|---|---|---|
| Anode | Pb | Pb | Pb | Covered Pb | Covered Pb |
| Cu⁺ | 40.6 | 57.0 | 37.4 | 44.3 | 54.3 |
| Cu²⁺ | 59.4 | 43.0 | 62.6 | 55.7 | 45.7 |
| S²⁻ | 18.4 | 20.6 | 43.2 | 43.3 | 42.7 |
| S₂²⁻ | 50.6 | 39.2 | 29.2 | 22.7 | 13.2 |
| S^{x-} | 31.0 | 40.2 | 27.6 | 34.0 | 44.1 |
| S/Cu ratio | 3.0 | 1.8 | 0.9 | 1.1 | 0.4 |

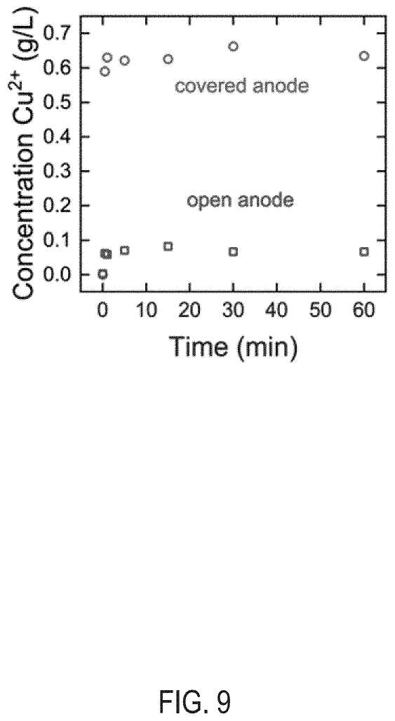

Referring now to FIG. 9, the amount of copper readily extracted from the products of the electrochemical reactor by oxidation with Fe³⁺ is shown. Without wishing to be bound by theory, the results indicate that covering the anode material may be beneficial for the electrochemical reactor because Cu₂O is more readily oxidized than CuS, albeit at the expense of an increased cell potential. The copper balance was completed by dissolving the product solids in aqua regia. It was verified that insignificant quantities plated to the cathode or remained in solution at the end of the experiment.

Batch experiments were conducted to assess the effect of the cathode material, the applied current density, the ratio of electrode surface area to reactor volume, and the use of a separator on the electrochemical conversion of CuFeS₂ to less refractory mineral phases. The electrode materials explored in this study resulted in similar faradaic efficiencies, indicating that low-cost materials such as lead or copper should be used. Low current densities and high ratios of electrode surface area to reactor volume resulted in the most efficient processing of CuFeS₂. The use of a porous separator to isolate the anode from mineral contact allowed for the electrochemical formation of Cu₂O, and thus improved the subsequent extraction of copper. Based on the design principles of the batch reactor experiments, a fixed bed cathode reactor was developed for the continuous electrochemical conversion of CuFeS₂. The fixed bed reactor enabled rapid and relatively efficient processing of CuFeS₂ concentrate and may be economically viable if scaled-up for high conversion.

Chalcopyrite mineral concentrate was kindly provided by Freeport-McMoRan. It was analyzed by the supplier with energy dispersion X-ray diffraction to have the following composition:

TABLE 5
Mineralogy of concentrate supplied by Freeport-McMoRan

| Mineral | Chemical Formula | Percent |
|---|---|---|
| Chalcopyrite | CuFeS₂ | 78.3 |
| Pyrite | FeS₂ | 12.9 |
| K-feldspar | KAlSi₃O₈ | 2.9 |
| Plagioclase | NaAlSi₃O₈ | 2.9 |
| Quartz | SiO₂ | 2.2 |
| Molybdenite | MoS₂ | 0.85 |

The mineral concentrate used in experimentation was sieved (−140+270 mesh) to confine the size distribution of the particles to be within 53-106 which is amenable to industrial practice. The sieved concentrate was rinsed with DI water followed by 1M H₂SO₄, followed by DI water to remove soluble iron and copper ions that were found to reside within the concentrate dust.

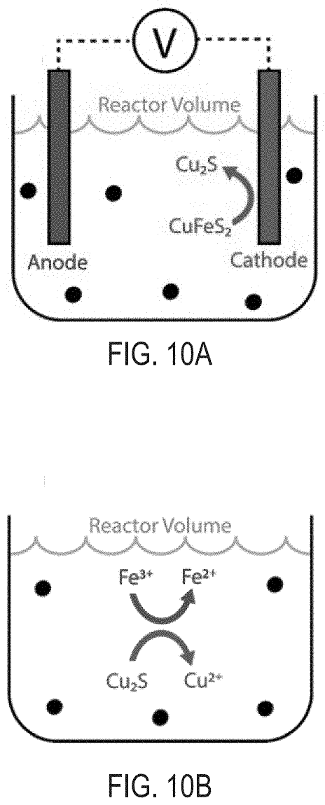

FIGS. 10A-10B show an overview of the two experiments conducted to convert CuFeS₂ into Cu²⁺ ions. FIG. 10A shows the electrochemical conversion of CuFeS₂ to Cu₂S or Cu₂O. The batch reactor included 50 mL of 1M H₂SO₄ in DI water and 20 g/L of the mineral concentrate, which was stirred continuously. The anode material for the reactor was lead of 99.8% purity (Alfa Aesar), which was chosen for its electrochemical stability. For some experiments, the lead anode was covered with Grade 1 Whatman filter paper of pore size 11 μm (Sigma Aldrich) to isolate the anode from mineral contact. The surface area of the anode was generally 1 cm², although where indicated, the surface area of the anode was increased. Several cathode materials of the electrochemical reactor were tested including 99.8% niobium (Alfa Aesar), 99.95% tungsten (Alfa Aesar), 99.9% copper (Alfa Aesar), 99.9% platinum (Alfa Aesar), 99.997% aluminum (Alfa Aesar), and 99.8% lead (Alfa Aesar). These cathode materials were chosen due to their varied performance in the hydrogen evolution reaction, which is a side reaction in the electrochemical reactor. The surface area of the cathode in solution was generally 1 cm², although for the copper cathode, the surface area was varied between 1, 2, 4, and 8 cm². An Ivium-n-Stat Potentiostat was used to apply a constant current between the electrodes for three hours while monitoring the cell potential. The current density applied between the electrodes was generally 10 mA/cm². Although for experiments conducted with the copper cathode, the current density was varied between 10, 50, 100, and 300 mA/cm².

Samples were taken from the reactor at time points of 0, 15, 30, 60, 90, 120, 150, and 180 minutes. The solid minerals within the samples were settled by centrifugation at 6000 rpm for approximately one minute and were subsequently diluted with DI water to lower the Fe²⁺ concentration to be within the range of 0-4 ppm. Concentrations of Fe²⁺ in the diluted samples were measured with a Thermo Scientific iCE 3000 Series atomic absorption spectrometer (AAS). A linear (R²>0.99) five-point calibration curve was measured immediately before the collected samples.

FIG. 10B shows the subsequent oxidation of the mineral products with the Fe³⁺ ion to extract Cu²⁺ ions from the products of the electrochemical reactor. Immediately following the electrochemical experiments, iron (III) sulfate hydrate (Sigma Aldrich) was added to the reactor to achieve an Fe³⁺ concentration of 1M. The Fe³⁺ ion oxidized the products of the electrochemical reactor to release Cu²⁺ ions. The copper cathode was removed from the reactor prior to oxidation to ensure that Cu²⁺ was solely released from the minerals. Samples were taken from the reactor at time points of 0, 5, 10, 20, 40, and 60 minutes after the addition of the oxidant. The samples were centrifuged, diluted with DI water, and measured for copper content with AAS using the same procedure described above.

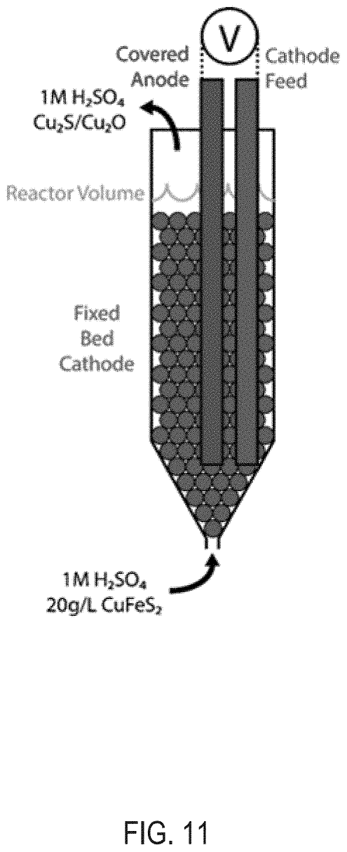

FIG. 11 shows a depiction of an electrochemical packed bed reactor that was used for the continuous treatment of CuFeS₂. The diameter and volume of the reactor were 1.5 cm and 10 mL, respectively. The anode material of the reactor was 99.8% lead (Alfa Aesar) and was covered with Whatman filter paper (Sigma Aldrich) to prevent short-circuiting of the electrochemical system. The filter paper also isolated the anode from contact with the solid mineral phase. The cathode feed was 99.8% lead (Alfa Aesar), and the packed bed consisted of lead spheres of diameter 0.08 in and 98% lead content (McMaster Carr). A 1 L slurry of chalcopyrite was prepared consisting of 1 M H₂SO₄ and 20 g/L of the chalcopyrite concentrate. A Cole-Parmer Masterflex L/S peristaltic pump was used to pump the chalcopyrite slurry through the reactor and into collection tubes at a flow rate of 12.7 mL/min. A constant current was applied between the electrodes using an Ivium-n-Stat Potentiostat and the cell potential was monitored. The collection tube was replaced every three minutes to monitor the progression of the electrochemical reaction over time. The residence time of the slurry in the reactor was approximately 22 s. Each collection tube was measured for iron content using AAS. Immediately following sample collection, iron (III) sulfate hydrate (Sigma Aldrich) was added to each sample to achieve an Fe³⁺ concentration of 1M. The sample was mixed for 30 minutes and the release of Cu²⁺ ions was measured using AAS.

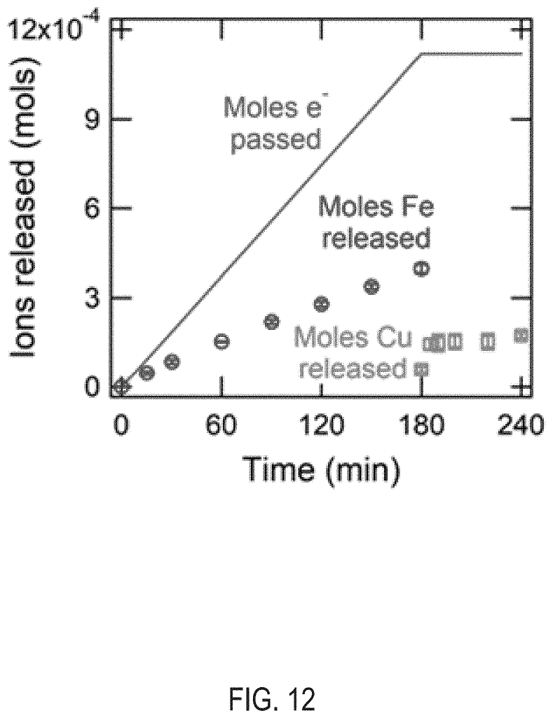

FIG. 12 shows the measured release of Fe³⁺ ions into the batch reactor coinciding with the application of current. The release of Fe³⁺ ions corresponds to the conversion of CuFeS₂ to Cu₂S according to Reaction 1. The formation of CuS and Cu₂O mineral products cannot be probed by the measurement of the Fe³⁺ ion and are instead measured by their release of Cu²⁺ ions in a subsequent oxidation reaction. FIG. 12 shows the extraction of Cu²⁺ ions of the mineral products subsequent to the electrochemical treatment. The molar ratio of Cu²⁺ released to Fe²⁺ released was approximately 0.5, which indicates that the product of the electrochemical reaction was likely Cu₂S, as measured in the literature.

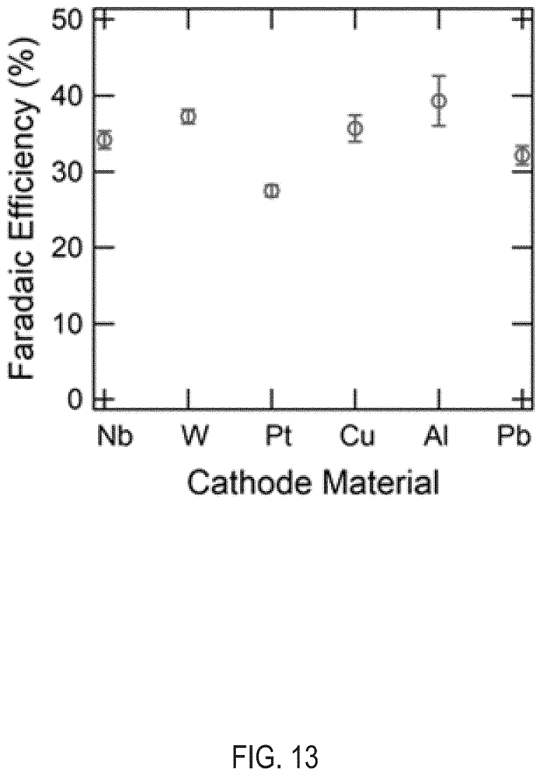

The fraction of the applied current that led to Reaction 1 is defined to be the faradaic efficiency (f), which is given by Equation 3. It was assumed that one electron releases one Fe²⁺ ion and hence converts one CuFeS₂ according to the stoichiometry of Reaction 1.

$$f = \frac{FV}{i} {\int }_{t = 0 min}^{t = 180 min} \frac{{c}_{F e}}{t} dt \times 100 \% \qquad [ 3 ]$$

Where V represents the volume of the reactor, c_{Fe} represents the concentration of Fe²⁺, i represents the current density, F represents Faraday's coefficient, and t represents time. FIG. 13 shows the faradaic efficiency of Reaction 1 for the various cathode materials that were investigated in this study. The integral for Equation 3 was estimated using a Riemann sum of the obtained data set. Differences in the faradaic efficiency of Reaction 1 for the various cathodes were marginal, while differences in the cell potentials for the various cathodes were not significant. Faradaic efficiencies below 100% are likely due to hydrogen evolution at the cathode. The data suggest that Pt is a poor choice of cathode due to its proclivity for hydrogen evolution and cost. Without wishing to be bound by theory, the best-choice cathode may be Pb due to its low cost, electrochemical stability, and current use in electrowinning in the copper industry. It should be noted, however, that Cu may be an alternative cathode due to its abundance in the copper industry.

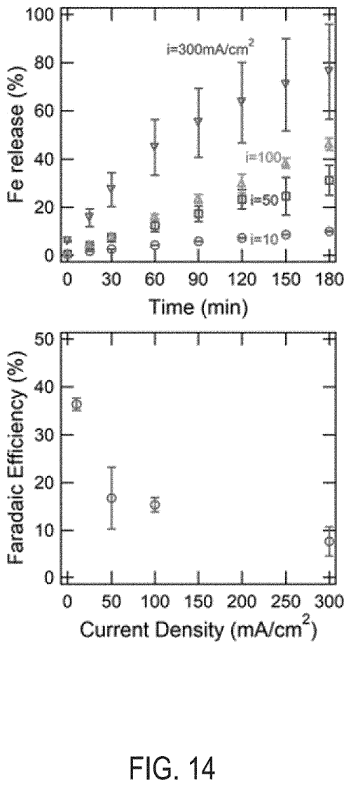

FIG. 14 shows the effect of current density on the electrochemical conversion of CuFeS₂. The percent of Fe²⁺ and Cu²⁺ ions released from CuFeS₂ into solution as discussed above. There exists a trade-off between the rapid conversion of CuFeS₂ and the faradaic efficiency of the reaction. High current densities, such as 300 mA/cm², lead to fast conversion of CuFeS₂ but operate at low faradaic efficiencies. Conversely, low current densities, such as 10 mA/cm², operate at acceptable faradaic efficiencies but require larger reactor volumes to achieve high conversion. The faradaic efficiency should probably be at least 20% to ensure that the cost of electricity for the electrochemical treatment (e.g., ˜$0.07/kWh) is significantly lower than the price of copper (e.g., ˜$6/kg). In the subsequent oxidation step (not shown), the ratio of copper release to iron release was consistently 0.5 for these experiments, indicating that the product of the electrochemical reactions was predominantly Cu₂S, as measured in the literature.

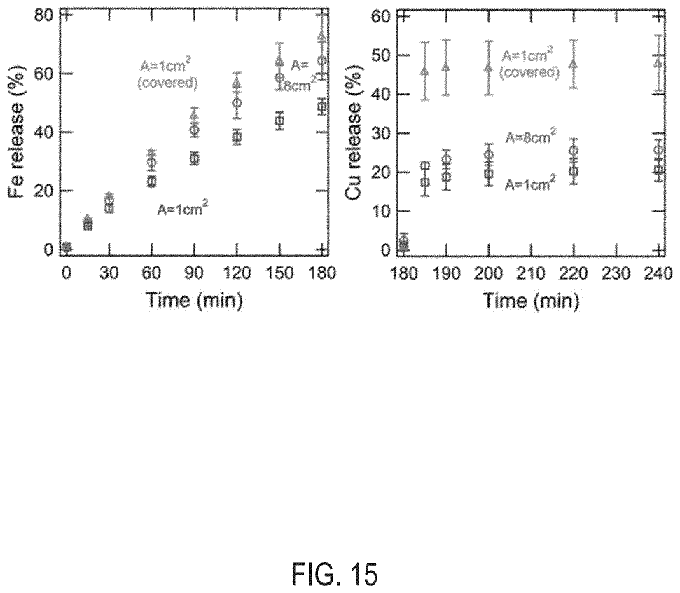

FIG. 15 shows XRD spectra for the chalcopyrite concentrate and the reaction products after 1 hr, 2 hr, and 3 hr of electrochemical treatment with a Cu cathode, and a current density of 300 mA/cm². The peaks of the unreacted chalcopyrite concentrate (0 hr label) can be attributed to CuFeS₂ (Reference code: 00-037-0471), FeS₂ (Reference code: 00-042-1340), and SiO₂ (Reference code: 00-033-1161), which is consistent with the mineralogical analysis shown in Table 5. The XRD patterns of the mineral products of the electrochemical treatment show the emergence of Cu₂₉S₁₆, which is considered to be Cu₂S with defects (Reference code: 00-023-0958) and CuS (Reference code: 01-078-2121). Formation of the Cu₂S and CuS mineral phases are consistent with literature results conducted with a Pb cathode, which indicates that the mineral products are likely independent of the cathode material used in experimentation. The emergence of the Cu₂S and CuS mineral phases are consistent with the release of Fe²⁺ ions shown by Reactions 1 and 2 as well as the subsequent release of Cu²⁺ ions upon chemical oxidation shown by the following Reactions 6 and 7.

Cu₂S+2Fe³⁺→CuS+Cu²⁺2Fe²⁺ [6]

CuS+2Fe³⁺→Cu²⁺+2Fe²⁺+S [7]

The XRD spectra also indicate that FeS₂ and silicates are inert throughout the electrochemical treatment.

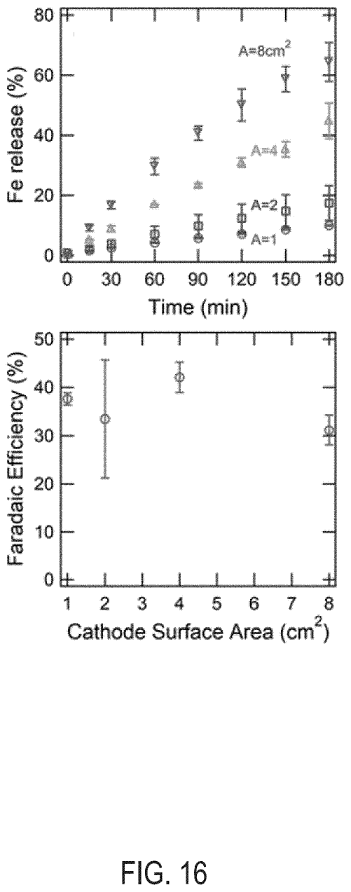

FIG. 16 shows electrochemical reduction experiments conducted at 10 mA/cm² with Cu cathodes of varying surface areas. The surface area of the Pb anode was the same as the cathode for each of these experiments. The results indicate that increasing the surface area leads to an increase in reaction conversion while maintaining high faradaic efficiency. Without wishing to be bound by theory, it is desirable to maximize the ratio of electrode surface area to reactor volume during the electrochemical treatment. The drop in efficiency for an electrode surface area of 8 cm² was likely due to the low pulp density of CuFeS₂ remaining in the reactor after ˜50% had been converted. In the subsequent oxidation step (not shown), the ratio of copper release to iron release was consistently 0.5, indicating that the product of the electrochemical reactions was predominantly Cu₂S for these experiments.

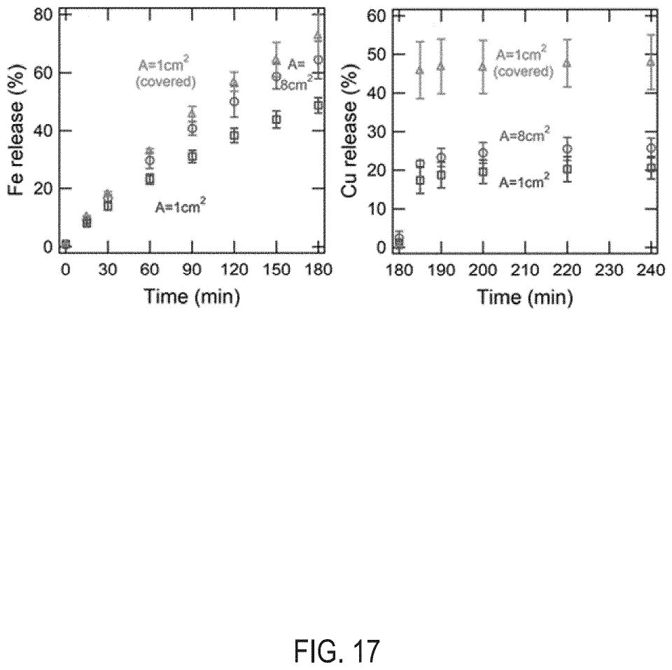

FIG. 17 shows Fe²⁺ release for different exposed surface areas of the anode. The results show that the Fe²⁺ release does not greatly depend on the exposed surface area of the anode. The faradaic efficiencies associated with Fe²⁺ release were 34%, 28%, and 36% for the exposed anode surface areas of 8 cm², 1 cm² and the covered anode, respectively. The decrease in efficiency for the anode surface area of 1 cm² might be attributed to nonuniform current distributions at the cathode. Although the conversion of CuFeS₂ was similar for the three experiments, the subsequent release of Cu²⁺ ions upon oxidation were significantly different. Covering the anode allows for the progression of Reaction 4 and hence greater copper extraction.

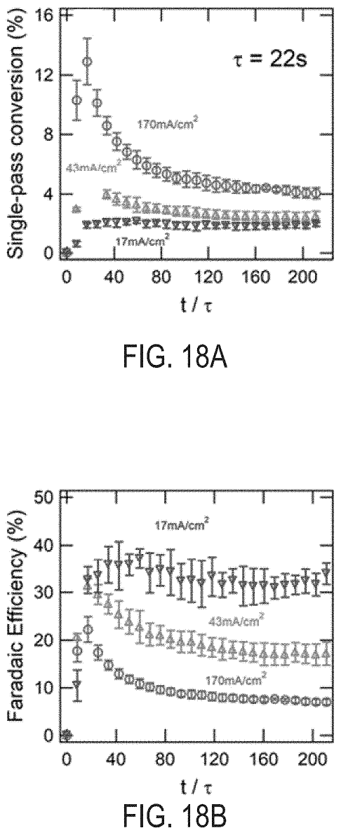

Continuous treatment of CuFeS₂ was conducted with an electrochemical packed bed reactor with the methodology illustrated in FIG. 11. This reactor design employs a high cathode surface area, an anode isolated from mineral contact, and a small distance between electrodes to minimize cell potential. FIG. 18A shows the instantaneous conversion of CuFeS₂ over the progression of time, while FIG. 18B shows the instantaneous faradaic efficiency. For the continuous system, the faradaic efficiency was calculated with Equation 4:

$$f = \frac{{c}_{F e} Q F}{i} \qquad [ 4 ]$$

where Q is the volumetric flow rate of the slurry through the reactor. The packed bed cathode surface area was an order of magnitude greater than the anode surface area; however, the electrically active area of the cathode may be limited to regions near the anode. Therefore, the current is normalized by the anode surface areas for the current densities shown. The residence time (τ) of CuFeS₂ in the reactor was approximately 22 s. After approximately 160 residence times, the release of Fe²⁺ ions from the minerals reached a steady-state. The reason that the Fe²⁺ release increased and then subsequently decreased with time is not fully understood but is thought to be associated with the accumulation of minerals within the reactor. The results are promising despite the low yield due to the small residence time of 22 s. Without wishing to be bound by theory, increased residence times should provide greater CuFeS₂ conversion.

The cell potential (V_{cell}) across the electrochemical packed bed reactor was approximately 2.5, 2.7, and 2.8 V at current densities of 17, 43, and 170 mA/cm², respectively. The results are consistent with the batch experiments, which show that it may be desirable to process CuFeS₂ at low current densities for greater faradaic and voltage efficiencies. The power requirement, which is related to electricity costs, is directly related to V_{cell} by Equation 5.

P=IV_{cell} [5]

The cost of electricity associated with CuFeS₂ conversion from concentrate is approximately $0.21/kg Cu by assuming an industrial cost of electricity of $0.07/kWh, a cell potential of 2.5V, and a faradaic efficiency of 35%. However, there are additional operating costs associated with pumping the concentrate slurry.

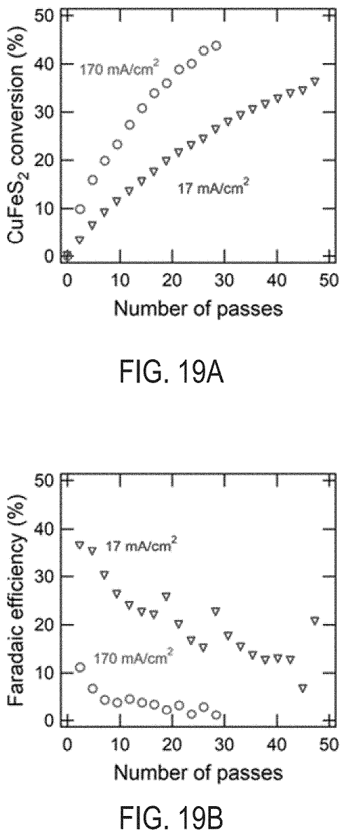

FIG. 19A shows the CuFeS₂ conversion as a function of the number of passes through the fixed bed reactor, which was attained by recirculating the slurry. A number of 50 passes is equivalent to a residence time of 18.3 minutes, considering that each pass has a residence time of 22 s. The results show that 36% of the CuFeS₂ was converted within the 18 minute residence time, which is a notable improvement to the batch experiments. The rapid conversion achieved with the fixed bed reactor demonstrates its promise for the electrochemical treatment of CuFeS₂. FIG. 19B, however, shows that the faradaic efficiency diminishes with the number of passes. The accumulation of Fe²⁺ ions within the reactor is a plausible cause for the decline in efficiency but is also inconsistent with the batch experiments, which were not as hindered from similar extents of Fe²⁺ release. Reactor plugging is another potential cause for the reduction in efficiency, although the single-pass experiments were not as hindered from potential plugging despite the same operating conditions. It has been observed that mineralogical intermediates formed during the electrochemical treatment adhere to the cathode, and these intermediates may cause plugging and a reduction in efficiency. The fixed bed reactor may be optimized to maintain high efficiency by optimizing its dimensions and flow rate to mitigate plugging. Overall, the use of a fixed bed reactor is thought to be a promising approach for the electrochemical treatment of CuFeS₂ concentrate due to the rapid and relatively efficient processing.

Methods and systems of the present disclosure are advantageous to electrochemical process chalcopyrite to another mineral that can be more easily processed by hydrometallurgy while simultaneously producing copper metal, which is more environmentally sustainable. The lead cathode and covered lead anode allow for efficient and inexpensive processing of chalcopyrite by preventing the mineral from contacting the lead anode allows for further conversion into a copper-oxide mineral phase. The cost of this technique is comparable to industry standards, and moreover, has a much smaller environmental footprint than heat-based copper extraction. In all, this technology provides a safe, affordable way to extract copper from chalcopyrite, regardless of the quality of the ore. A preliminary cost analysis suggests that the total cost is approximately $6.2 per kg of copper, which makes the process competitive with industrial standards. Thus, the present disclosure represents a means of increased domestic production of copper, using a process that can probably more easily exploit renewables.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A method for production of copper ions, comprising:
providing a sample including an amount of chalcopyrite (CuFeS₂);
providing an electrochemical reactor including an anode, a cathode, and an electrolyte in communication with the anode and the cathode,
providing the sample to the electrochemical reactor;
applying a potential between the anode and the cathode to produce a first product including cuprite (Cu₂O); and
applying an oxidizing agent to the first product to oxidize the Cu₂O to produce a second product including copper ions.

2. The method according to claim 1, wherein a porous separator is positioned between the sample and the anode.

3. The method according to claim 2, wherein the anode is covered by the porous separator.

4. The method according to claim 3, wherein the porous separator includes filter paper.

5. The method according to claim 1, wherein:
the cathode is composed of niobium, tungsten, platinum, copper, aluminum, lead, or combinations thereof, and
the anode is composed of niobium, tungsten, platinum, copper, aluminum, lead, or combinations thereof.

6. The method according to claim 1, wherein the cathode further comprises a bed of cathode material particles.

7. The method according to claim 1, wherein the ratio of cathode surface area (cm²) to electrochemical reactor volume (mL) is above about 0.15.

8. The method according to claim 1, wherein applying a potential between the anode and the cathode to produce a first product including cuprite (Cu₂O) includes:
operating the electrochemical reactor at a current density less than about 50 mA/cm².

9. The method according to claim 1, wherein the oxidizing agent includes a source of Fe³⁺ ions.

10. The method according to claim 1, wherein providing a sample including an amount of CuFeS₂ further comprises:
grinding the sample to have an average particle size between about 50 μm and about 110 μm.

11. A system for production of copper ions, comprising:
a source of chalcopyrite (CuFeS₂);
an electrochemical reactor in communication with the source of CuFeS₂, the electrochemical reactor including:
an anode covered by a porous separator;
a cathode;
an electrolyte in communication with the anode and the cathode; and
at least one product outlet,
a first product stream in communication with the at least one product outlet, the first product stream including cuprite (Cu₂O);
a source of Fe³⁺ ions in communication with the first product stream; and
a second product stream in communication with the first product stream, the second product stream including copper ions.

12. The system according to claim 11, wherein the ratio of cathode surface area (cm²) to electrochemical reactor volume (mL) is above about 0.15.

13. The system according to claim 11, wherein:
the cathode is composed of niobium, tungsten, platinum, copper, aluminum, lead, or combinations thereof, and
the anode is composed of niobium, tungsten, platinum, copper, aluminum, lead, or combinations thereof.

14. The system according to claim 11, wherein the cathode further comprises a bed of cathode material particles.

15. The system according to claim 11, wherein the electrochemical reactor is operated at a current density less than about 50 mA/cm².

16. A system for production of copper ions, comprising:
a source of chalcopyrite (CuFeS₂);
a source of Fe³⁺ ions;
an electrochemical reactor in communication with the source of CuFeS₂ and the source of Fe³⁺ ions, the electrochemical reactor including:
an anode;
a cathode;
an electrolyte in communication with the anode and the cathode;
a potentiostat; and
at least one product outlet,
and,
a product stream in communication with the at least one product outlet, the product stream including copper ions,
wherein the ratio of cathode surface area (cm²) to reactor volume (mL) is above about 0.15, and the potentiostat operates the electrochemical reactor at a current density less than about 50 mA/cm².

17. The system according to claim 16, wherein a porous separator is positioned to isolate the anode from contact with the CuFeS₂.

18. The system according to claim 17, wherein the anode is covered by at least one layer of filter paper.

19. The system according to claim 16, wherein:
the cathode is composed of niobium, tungsten, platinum, copper, aluminum, lead, or combinations thereof, and
the anode is composed of niobium, tungsten, platinum, copper, aluminum, lead, or combinations thereof.

20. The system according to claim 16, wherein the cathode further comprises a bed of cathode material particles.
